(19) United States
(12) Patent Application Publication
(10) Pub. No.: US 2008/0304487 A1
(43) Pub. Date: Dec. 11, 2008

(54) Enhancing subscriber location tracking mechanism for voice over internet protocol services

(75) Inventor: Lalit Ratilal Kotecha, Union City, CA (US)

Correspondence Address: MCDERMOTT WILL & EMERY LLP, 600 13TH STREET, N.W., WASHINGTON, DC, 20005-3096, US

(73) Assignee: CELLO PARTNERSHIP

(21) Appl. No.: 11/808,040

(22) Filed: Jun. 6, 2007

(51) Int. Cl. H04L 12/66; H04L 12/56

(52) U.S. Cl. 370/392; 455/466

(57) ABSTRACT

A system for providing a Voice over Internet Protocol (VoIP) service has an Internet Protocol (IP) address detector for detecting an IP address assigned to a customer by an IP network during a VoIP communication session with the customer. An IP address database stores detected IP addresses. The IP address detector is configured for detecting a first IP address assigned to a customer during a first VoIP communication session with the customer, and for detecting a second IP address assigned to the customer during a second VoIP communication session with the customer. The second IP address is compared with the first IP address to produce an address change signal indicating a change in a physical location of the customer when the second IP address does not correspond to the first IP address.

### TECHNICAL FIELD

This disclosure relates to wireless communications, and more particularly, to an enhanced mechanism for tracking location of a subscriber that uses Voice over Wireless Local Area Network (VoWLAN) services.

### BACKGROUND

Two key trends are driving development of modern communication technologies. The first is the broad migration to Voice over Internet Protocol (VoIP), a technology that provides telephone communication services over Internet Protocol (IP) packet switched networks. The second is the transition to wireless mobile computing supported by wireless local area networks (WLANs). These trends are combined in the VoWLAN technology that delivers voice communication services over wireless local area networks.

Voice is a demanding application. It requires near-continuous network transmission and very low packet loss to avoid latencies (gaps in communication) and jitter which can impact clarity. Voice transmission over wireless networks is even more challenging technology because mobile usage introduces additional problems. Some voice applications involve knowledge of a calling or called party's location, eg. for processing associated with a 911 call. As wireless subscribers move out of their offices or homes, they may interface with the IP network through several different access points.

The VoWLAN technology is based on a radio access technology such as Wireless Fidelity (WiFi), Worldwide Interoperability for Microwave Access (WiMAX), Ultra Mobile Broadband (UMB), or Long Term Evolution (LTE). VoWLAN technology supports connection of a subscriber's handset or other mobile terminal arranged in a WLAN to an IP network linked to a wireless network such as a Code Division Multiple Access (CDMA) or Global System for Mobile Communications (GSM) network that may be provided by a cellular telecommunications operator.

CDMA or GSM network providers are required by the Federal Communications Commission (FCC) to provide Enhanced 911 (E911) service that automatically associates physical addresses of subscribers with their telephone numbers. The E911 system is an emergency-calling system that provides emergency responders with the location of the emergency without the person calling for help having to provide it. This is often useful in times of fires, break-ins, kidnapping, and other events where communicating one's location is difficult or impossible. In the United States, the E911 service is activated if the emergency telephone number such as 911 is called. Outside the United States, this type of service is often called Caller Location. Its implementation is dependent on how the telephone network processes emergency calls.

The final destination of a E911 call is a Public Safety Answering Point (PSAP) where a 911 operator is located. There may be multiple PSAPs within the same exchange or one PSAP may cover multiple exchanges. Most PSAPs have a regional Emergency Service Number, a number identifying the PSAP. The location information provided to the PSAP is normally integrated into emergency dispatch center's computer-assisted dispatch (CAD) system, to provide the dispatcher with an on screen street map that highlights the caller's position and the nearest available emergency responders. For landline E911, the location is an address of a caller which bears a fixed relationship to the end port of the line and thus to the caller's telephone number. For wireless E911, the location is a coordinate of a caller, which may be determined using Global Positioning System (GPS) technology.

Subscriber location also may be determined in a Communications Assistance for Law Enforcement Act (CALEA) system. The CALEA, passed in October 1994, mandates telecommunications carriers to preserve the ability of law enforcement agencies to conduct electronic surveillance by requiring that telecommunications carriers and manufacturers of telecommunications equipment modify and design their equipment, facilities, and services to ensure that they have the necessary surveillance capabilities. The CALEA imposes specific obligations on telecommunications carriers to assist law enforcement with respect to call intercept, accessing call identifying information, and delivering intercepted communications and call identifying information to the government.

In a VoIP system, detection of subscriber location for E911 or CALEA presents complicated technical problems. VoIP phones are on the Internet and moving from place to place. Therefore, the location of the individual placing the call can be very difficult to determine. Current VoIP service requirements include pre-registering subscriber location in a subscriber location database before providing VoIP services. However, if a subscriber moves from one location to another, authorities have no means to find the subscriber location unless the subscriber reports a change in her address.

One of methods currently used for finding location of a VoIP subscriber is pre-registering a Media Access Control (MAC) address of WLAN Access Point given to the subscriber by a VoIP service provider. However, a subscriber may connect her WLAN Access Point to an IP network at a location different from the original subscriber location registered in the database. Also, a subscriber may use a WLAN Access Point device different from the device issued by the VoIP provider.

Therefore, there is a need for an enhanced subscriber location tracking mechanism that would make it possible to detect a change in location of a VoIP subscriber and register this change in a subscriber location database.

### SUMMARY OF THE DISCLOSURE

A data communication system and method are disclosed herein, which incorporate concepts to address above noted problems with subscriber location tracking for a VoIP service and result in enhancing subscriber location tracking.

In accordance with one aspect of the disclosure, a system for providing a VoIP service comprises an IP address detector for detecting an IP address assigned to a customer by an IP network during a VoIP communication session with the customer, and an IP address database for storing IP addresses of customers. The IP address detector is configured for detecting a first IP address assigned to a customer during a first VoIP communication session with the customer, and for detecting a second IP address assigned to the customer during a second VoIP communication session with the customer. The second IP address is compared with the first IP address to produce an address change signal indicating a change in a physical location of the customer when the second IP address does not correspond to the first IP address.

For example, the IP address data base may store IP addresses in association with telephone numbers of the respective customers. Also, the IP addresses may be stored in association with MAC addresses of VoIP access points assigned to the respective customers.

In accordance with an embodiment of the disclosure, a VoIP access to an IP network may be provided over a WLAN.

In response to the address change signal produced by the IP address detector, the customer may be supplied with a request to submit an updated physical address. For example, an address update request message, such as a Short Message Service (SMS) or Multimedia Message Service (MMS) message, may be automatically sent to the customer over a wireless network.

Also, an address update request message may be sent over an IP network. Alternatively, a voice call to the customer may be automatically generated in response to the address change signal to send a voice message requesting the customer to update the physical address. When a location change is detected, the customer may be automatically prevented from using the VoIP service.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF DRAWINGS

The following detailed description of the embodiments of the present disclosure can best be understood when read in conjunction with the following drawing figures that depict concepts by way of example, not by way of limitations. In the figures, like reference numerals refer to the same or similar elements.

FIG. 1 depicts an exemplary network environment, in which a change in subscriber's location may be detected in accordance with the present disclosure.

FIG. 2 illustrates a technique for requesting a subscriber to update the physical address.

FIG. 3 illustrates actions taken when a subscriber provides an updated physical address.

### DETAILED DISCLOSURE OF THE EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The present disclosure will be made using the example of tracking location of a subscriber that uses a WiFi technology to access VoWLAN services in a wireless network. It will become apparent, however, that the concept of the disclosure is applicable to determining location of a subscriber that uses any radio-access technology, such as WiMAX, WiFi/WiMAX, LTE/WiFi, LTE/WiMAX, UMB/WiFi, UMB/WiMAX, in any IP-based communication system.

Also, in the disclosed examples, subscriber location is tracked to support the E911 service. However, one skilled in the art would realize that a location tracking mechanism of the present disclosure may be utilized in any service that needs to determine location of a calling party without GPS technology.

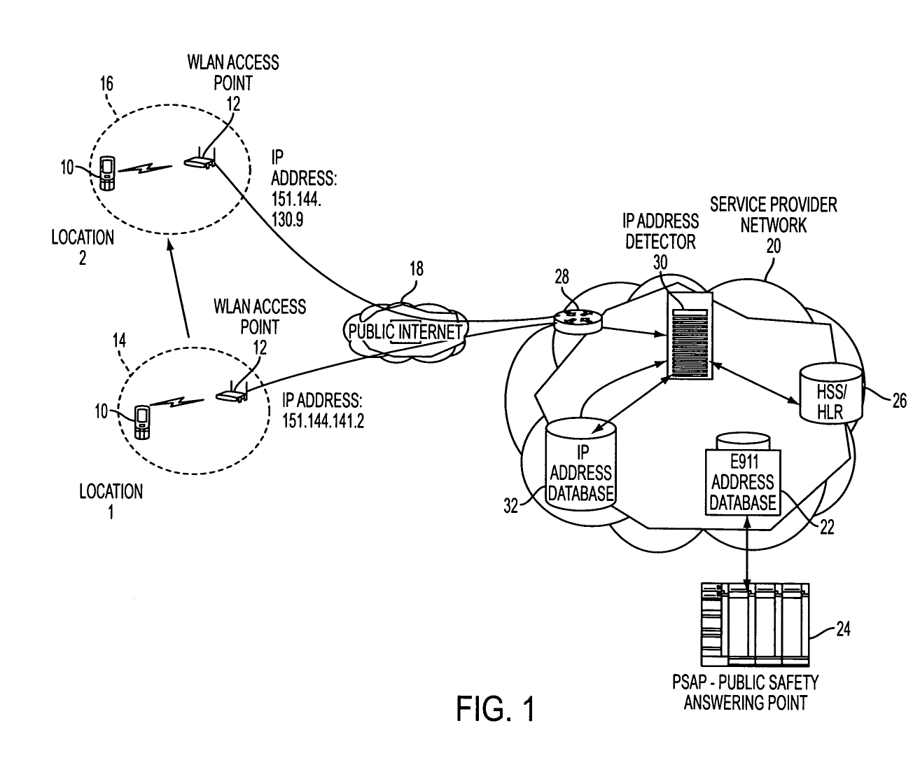

FIG. 1 schematically illustrates an exemplary data communications environment, in which a system and a method of the present disclosure can be implemented. The drawing shows an example of a subscriber's mobile station 10 that moves from location 1 to location 2. The mobile station 10 may be any device capable of providing wireless communications, such as dual-mode handset, personal digital assistant, or laptop type personal computer.

At the location 1, the subscriber's mobile station 10 uses a WLAN access point 12 to operate in a WLAN 14. The WLAN access point 12 serves as a base station, such as a router, that supports communications within the respective WLAN and connects mobile stations of the WLAN to a public Internet network 18 or any other outside IP network.

At the location 2, the mobile station 10 may be arranged in a WLAN 16 using the WLAN access point 12 that has been moved from the location 1 or a different WLAN access point. Although FIG. 1 shows that at both locations the WLAN access point 12 communicates with the same IP network 18, one skilled in the art would understand that different IP networks may be provided at the locations 1 and 2.

The mobile station 10 may be a dual-mode portable device enabled to operate in a WiFi mode to communicate via the WLAN access point 12, and in a radio-access mode, such as a CDMA or GSM mode, to communicate through a radio-access network (RAN) that may be provided by a wireless communications operator. In a typical application, the customer might set up the access point in her home or office to use the VoWLAN from that location but use a cellular CDMA or GSM service when outside of the home or office location.

The WLAN access point 12 may contain an antenna for receiving and transmitting WiFi signals to and from the mobile station 10, and a network port, such as an Ethernet port, for connecting the respective WLAN to the IP network 18 coupled to a service provider network 20 that may be arranged, for example, by a wireless communications operator, and may contain a telephone call processing platform, such as a Mobile Switching Center (MSC), that supports processing data packets carrying VoIP voice traffic, as well as processing wireless voice traffic, such as CDMA or GSM calls.

When a subscriber registers for a VoWLAN service available from a service provider, such as a wireless communications operator, she may receive a mobile station 10 and a WLAN access point 12 compatible with the service provider network 20. Each WLAN access point 12 has a MAC address that serves as a unique identifier of the respective WLAN. When the VoWLAN service is activated, the subscriber provides the physical address (e.g. mail address) of the location where the WLAN access point 12 is going to be used. Alternatively, subscribers may obtain required communication equipment on their own. In this case, they may be required to provide MAC addresses of their WLAN access points when the service is activated.

The service provider links the subscriber's physical address to the MAC address of the subscriber's WLAN access point, and stores the physical and MAC addresses in association with the subscriber's Mobile Station Dialing Number (MSDN) in an E911 address database 22 arranged in the service provider network 20. The E911 address database 22 stores subscriber's location information for each MSDN registered with the service provider to enable emergency responders at a PSAP 24 to establish the location of a person that places an emergency call, such as the 911 call. For example, the E911 address database may store the latitude and longitude of a location associated with the MSDN. In this case, the physical address of the subscriber may be transformed into the latitude and longitude of the respective location before entering the location into the E911 address database 22.

Also, the subscriber's address may be registered in a Home Subscriber Service/Home Location Register (HSS/HLR) database 26. This database is maintained by the service provider to identify valid subscribers and services, and to assist in call routing. For each subscriber, it may store such identification data as the assigned MSDN, MAC address of the subscriber's equipment, subscription service options, terminal capabilities, physical location, etc.

When the WLAN access point 12 is connected to the IP network 18 at the location 1, a fixed IP address may be assigned to the WLAN access point 12 by the Internet service provider. For example, FIG. 1 shows that at the location 1, the WLAN access point 12 has IP address 151.144.141.2. The assigned IP address may be used for any VoIP communications performed by the subscriber's mobile station 10 via the WLAN access point 12. For example, the WLAN access point 12 may have a Network Address Translation (NAT) function to allow all stations on the respective WLAN to communicate with outside devices using a single IP address. The NAT function enables the WLAN access point 12 to provide address translation “on the fly” as traffic passes from the mobile station 10 to the IP network 18 so as to produce IP data packets having the IP address assigned by the Internet provider.

Via an IP gateway 28, IP data packets from the subscriber's mobile station 10 are received for processing by the service provider network 20. Paths routers/switches and/or servers for voice communications are omitted for simplicity. In particular, for this discussion, the service provider network 20 may include an IP address detector 30 that detects the IP address received from the subscriber's mobile station 10. When the mobile station 10 makes the initial VoIP call, the IP address detector 26 detects the IP address associated with the subscriber's MSDN and stores this IP address, together with the MSDN, in an IP address database 32. Also, the IP address may be stored in association with the MAC address of the subscriber's WLAN access point. On the beginning of each VoIP session with a subscriber, the IP address detector 30 may retrieve from the IP address database 32 the IP address associated with that subscriber and compare the retrieved IP address with the current IP address of the subscriber to verify that the IP address of the subscriber remains the same. During the VoIP session with a customer, the IP address detector 30 may maintain the retrieved IP address in a local temporary storage.

If a subscriber moves to another location, for example, to the location 2, and does not register her new location with the service provider, the E911 address database 22 contains the wrong address information for that subscriber, which makes it impossible to accurately detect the subscriber's location during the 911 call. At the new location, the Internet service provider assigns the WLAN access point 12 of the subscriber with a new fixed IP address. For example, as shown in FIG. 1, the WLAN access point 12 at the location 2 may be assigned with IP address 151.144.130.9. When the subscriber initiates a VoIP session from the new location, the WLAN access point 12 connects the subscriber's mobile station 10 to the IP network 18 using the new IP address. At the beginning of the VoIP session, the IP address detector 30 compares the subscriber's IP address with the IP address stored in the IP address database 32 for the MSDN of that subscriber, and detects a change in the IP address. If at the location 2 the subscriber uses the same WLAN access point 12 as the WLAN access point used at the location 1, the IP address detector 30 will also determine that a different IP address is associated with the MAC address of the WLAN access point 12.

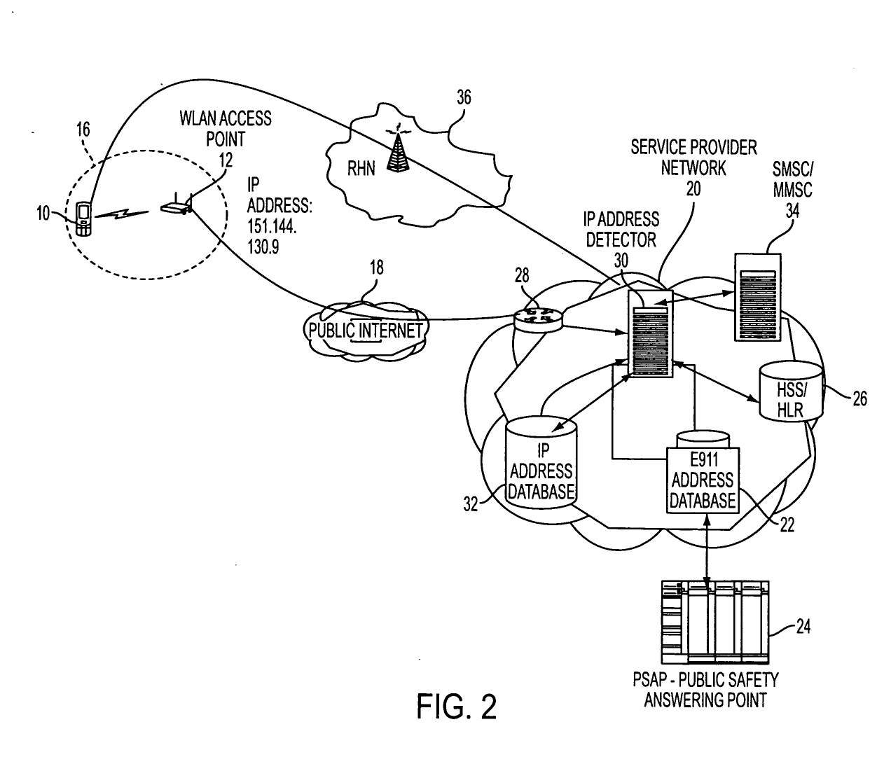

When the IP address detector 30 detects a change in the IP address associated with the MSDN of the subscriber and/or the MAC address of the subscriber's WLAN access point, the IP address detector 30 registers the new subscriber's IP address in the IP address database 32 and automatically initiates an address verification procedure illustrated in FIG. 2. In particular, in response to detecting a change in a subscriber's IP address, the IP address detector 30 may send a request to a Short Message Service Center/Multimedia Message Service Center (SMSC/MMSC) 34 to generate a Short Message Service (SMS) message or a Multimedia Message Service (MMS) message notifying the subscriber about the detected change in her address. The SMS or MMS message may be sent to the subscriber's mobile station 10 over the RAN 36 of a public cellular network or over the IP network 18.

At the same time, the IP address detector 30 may inform the HSS/HLR 26 that the subscriber has moved but her location is not updated. In response, the HSS/HLR 26 may flag the record relating to the subscriber to allow the VoIP service provider to make an appropriate action with respect to the subscriber. For example, the VoIP service provided to that subscriber may be blocked after a prescribed time period.

If the service provider network 20 sends an SMS message to the subscriber, the SMS message may request the subscriber to register an updated physical address within a specified time period. In response to this request, the subscriber may register her new address, for example, by making a telephone call to the service provider or inputting information over the Internet.

If an MMS message is sent to the subscriber, the MMS message may contain an appropriate address change form allowing the subscriber to insert the correct physical address and send the MMS message back. The return MMS message may enable the service provider network 20 to automatically extract the inserted address information and put it into the E911 address database 22.

Alternatively, instead of sending an SMS or MMS message, the service provider network 20 may initiate an automatic call to the subscriber's mobile station 10 over the RAN 36 or the IP network 18 when a change in the subscriber's IP address is detected. The subscriber may be provided with a voice message requesting update of address information.

If no action is taken by the subscriber in response to a request for updated address information within the specified time period, the service provider network 20 may automatically block the VoIP service to that subscriber. However, the subscriber may still be provided with communication services over the RAN 36.

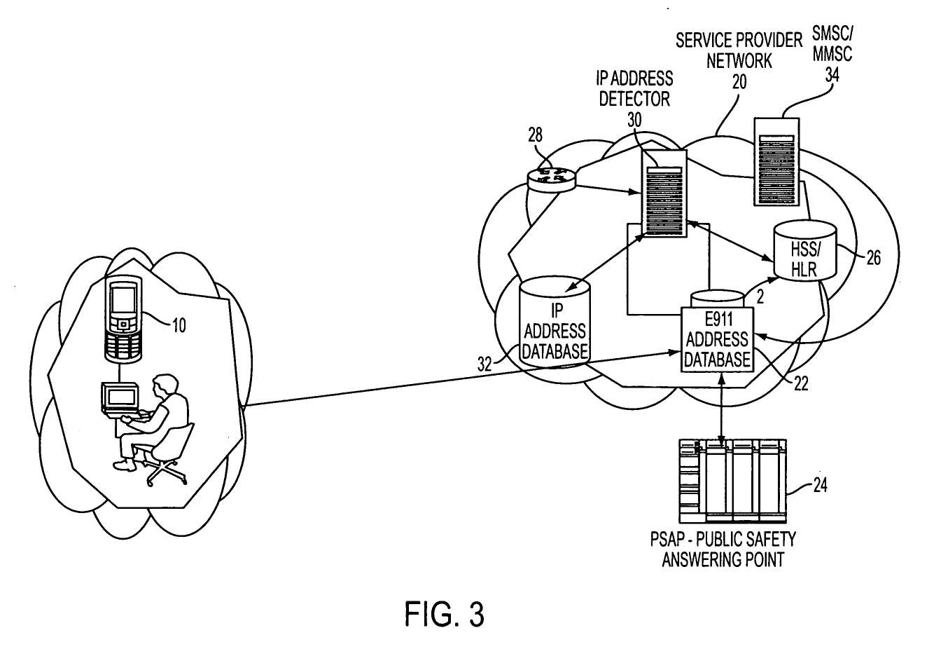

FIG. 3 illustrates actions taken when the subscriber supplies the service provider with an updated physical address. As described above, the subscriber may supply the service provider network 20 with an updated physical address in any appropriate manner. This address may be inserted in the E911 address database 22 to enable an emergency responder at the PSAP 24 to detect the subscriber's location during the E911 call placed by the subscriber. In response to entering the updated subscriber's address, the E911 address database 22 may inform the HSS/HLR 26 that a subscriber with a specific MSDN inserted a new physical address.

Upon receiving address update information from the E911 address database 22, the HSS/HLR 26 checks whether the record for a given subscriber has a flag indicating that the subscriber's IP address has been changed. If the flag is detected, the HSS/HLR 26 sends a confirmation notice to the IP address detector 30 to confirm that the IP address for a given subscriber in the IP address database 32 should be replaced with the detected new IP address.

The absence of the flag in the HSS/HLR 26 may indicate that a subscriber provides a new address before the IP address detector 30 detects a change in the IP address of that subscriber. In this case, the HSS/HLR 26 supplies the IP address detector 30 with the subscriber's identification information such as MSDN or MAC address of the subscriber's WLAN point, together with a new IP address if this address is provided by the subscriber.

If the IP address is available, the IP address detector 30 updates the subscriber's record in the IP address database 32. If the IP address is not available, the IP address detector 30 is requested to detect a new IP address during the next VoIP session with a given subscriber, and to update the IP address in the IP address database 32. To avoid an error condition, when a new IP address for a subscriber is not available, the IP address detector 30 may query the HSS/HLR 26 when a new VoIP session is established with that subscriber.

While the foregoing has described what are considered to be the best mode and/or other preferred examples, it is understood that various modifications may be made therein and that the invention or inventions disclosed herein may be implemented in various forms and examples, and that they may be applied in numerous applications, only some of which have been described herein.

It is intended by the following claims to claim any and all applications, modifications and variations that fall within the true scope of the present teachings.

What is claimed is:

1. A system for providing a Voice over Internet Protocol (VoIP) service comprising:
an Internet Protocol (IP) address detector for detecting a first IP address assigned to a customer by an IP network during a first VoIP communication session with the customer, and
an IP address database for storing the first IP address of the customer,
the IP address detector being configured for:
detecting a second IP address assigned to the customer during a second VoIP communication session with the customer,
accessing the IP address database to retrieve the first IP address of the customer,
comparing the second IP address with the first IP address, and
producing an address change signal indicating a possible change in a physical location of the customer when the second IP address does not correspond to the first IP address.

2. The system of claim 1, wherein the IP address database is configured to store the first IP address in association with a telephone number of the customer.

3. The system of claim 2, wherein the IP address detector is configured to retrieve the first IP address associated with the telephone number of the customer having the second IP address during the second VoIP communication session.

4. The system of claim 1, wherein the IP address database is configured to store the first IP address in association with a Media Access Control (MAC) address of a VoIP access point assigned to the customer.

5. The system of claim 4, wherein the IP address detector is configured to retrieve the first IP address associated with the MAC address assigned to the customer having the second IP address during the second VoIP communication session.

6. The system of claim 1, wherein the customer performs the VoIP communication sessions over a Wireless Local Area Network (WLAN).

7. The system of claim 1, wherein in response to the address change signal, the customer is supplied with a request to submit an updated physical address.

8. The system of claim 7, wherein in response to the address change signal, an address request message is automatically sent to the customer over a wireless network.

9. The system of claim 7, wherein in response to the address change signal, an address request message is automatically sent to the customer over an IP network.

10. The system of claim 7, wherein in response to the address change signal, a Short Message Service (SMS) message is automatically sent to the customer.

11. The system of claim 7, wherein in response to the address change signal, a Multimedia Message Service (MMS) message is automatically sent to the customer, the MMS message containing an address update form that can be filled by the customer.

12. The system of claim 7, wherein in response to the address change signal, a voice call to the customer is automatically generated.

13. The system of claim 1, wherein in response to the address change signal, the customer is automatically prevented from using the VoIP service.

14. A method of providing a Voice over Internet Protocol (VoIP) service, comprising the steps of:
detecting an Internet Protocol (IP) address provided to a customer's mobile station during a VoIP communication session,
comparing the detected IP address with a stored IP address associated with the customer's mobile station, and
generating a warning signal if the detected IP address does not correspond to the stored IP address.

15. The method of claim 14, wherein the stored IP address is detected during a previous VoIP communication session with the customer's mobile station.

16. The method of claim 14, wherein the stored IP address is held in association with a telephone number assigned to the customer's mobile station.

17. The method of claim 14, wherein the stored IP address is held in association with a Media Access Control (MAC) address of a Wireless Local Area Network (WLAN) access point supporting access of the customer's mobile station to an IP network.

18. The method of claim 14, wherein a message requesting update of a physical address is automatically sent over a wireless network to the customer's mobile station in response to generating the warning signal.

19. The method of claim 14, wherein a voice call requesting update of a physical address is automatically sent to the customer's mobile station in response to generating the warning signal.
